(19) United States
(12) Patent Application Publication
(10) Pub. No.: US 2016/0127418 A1
(43) Pub. Date: May 5, 2016

(54) POLICY-GUIDED FULFILLMENT OF A CLOUD SERVICE

(71) Applicant: HEWLETT PACKARD ENTERPRISE DEVELOPMENT LP, Houston, TX (US)

(72) Inventors: Stephane Herman Maes, Fremont, CA (US); Jan Alexander, Cupertino, CA (US)

(21) Appl. No.: 14/928,640

(22) Filed: Oct. 30, 2015

Related U.S. Application Data
(60) Provisional application No. 62/074,316, filed on Nov. 3, 2014.

(51) Int. Cl. H04L 29/06

(52) U.S. Cl. CPC H04L 63/20

(57) ABSTRACT

A model represents a cloud service to be provisioned over a cloud. A policy guides provisioning and subsequent management of the cloud service. The model is modified by introducing code corresponding to the policy into the model, the introduced code to perform at least one action with respect to a rule of the policy, the at least one action selected from among validating the rule and performing remediation with respect to the rule. Responsive to the modifying of the model, a set of instructions is generated including code for deploying an instance of the cloud service according to the model, and the introduced code to perform the at least one action with respect to the rule.

### CROSS-REFERENCE TO RELATED APPLICATION

This claims the benefit under 35 U.S.C. §119(e) of U.S. Provisional Application No. 62/074,316, filed Nov. 3, 2014, which is hereby incorporated by reference.

### BACKGROUND

A cloud service can refer to a service that includes infrastructure resources (a compute resource, a storage resource, a networking resource, etc.) connected with each other and/or platforms. Such infrastructure resources can collectively be referred to as “cloud resources.” A host (also referred to as a cloud service provider) may, as examples, provide Software as a Service (SaaS) by hosting applications or other machine-readable instructions; Infrastructure as a Service (IaaS) by hosting equipment (servers, storage components, network components, etc.); or a Platform as a Service (PaaS) by hosting a computing platform (operating system, hardware, storage, and so forth).

A public cloud is a place where IaaS or PaaS is offered by a cloud service provider. The services of the public cloud can be used to deploy applications. In other examples, a public cloud can also offer SaaS, such as in examples where the public cloud offers the SaaS as a utility (e.g. according to a subscription or pay as you go model).

In other examples, an IaaS can be deployed on premises of a customer, such as the customer's data center. Such an arrangement is referred to as a private cloud. A managed cloud is a private cloud that is managed by a third party or hosted and managed by a third party (if the private cloud is managed by a third party, then the managed cloud is referred to as a virtual private cloud).

In further examples, IaaS can be provided by traditional servers or data centers.

In other cases, a cloud used by a project or a customer can be a combination of all the above (e.g. applications have pieces in different cloud deployments or applications can be moved to different clouds or deployment models). Such a cloud is referred to as a hybrid cloud.

Application stacks (including a platform and operating system as well as other layers) in a cloud infrastructure can also be considered as cloud services. They may be “used” or offered as a service.

### BRIEF DESCRIPTION OF THE DRAWINGS

Some implementations are described with respect to the following figures.

FIG. 1 is a schematic diagram of an example arrangement that involves binding a policy to an environment defined by models, in accordance with some implementations.

FIG. 2 is a schematic diagram of an example arrangement that involves generating a workflow after binding of the policy to the environment defined by models, in accordance with some implementations.

FIG. 3 is a schematic diagram of execution of an example workflow, according to some implementations.

FIG. 4 is a flow diagram of an example process, in accordance with some implementations.

FIG. 5 is a block diagram of a service controller according to some implementations.

FIG. 6 is a block diagram of a system according to further implementations.

### DETAILED DESCRIPTION

There are generally two categories of approaches to manage and deploy cloud services. A first category uses external cloud controllers that model the cloud services and created instances of the cloud services. A second category uses cloud native applications, which are applications designed specifically for a cloud computing architecture and which provide cloud services.

The cloud controllers of the first category can also be referred to as “service controllers,” and are deployed to provision and/or manage cloud services. The use of the service controllers allow for traditional applications to be evolved and run on the cloud. An example of a service controller is a Cloud Service Automation (CSA) controller from Hewlett-Packard (HP), such as CSA Release 4.5. Although reference is made to the CSA controller as an example of a service controller, it is noted that other different service controllers can be employed in other implementations.

For the second category, cloud native applications can be developed using cloud technologies such as OpenStack or Cloud Foundry, as examples.

OpenStack is an open-source cloud operating system that controls pools of processing, storage, and communication resources, which can be managed using a dashboard to give administrators control. Cloud Foundry provides an open-source cloud computing platform as a service (PaaS). In other examples, other types of open-source cloud computing platforms can be provided.

Enterprises may employ a mix of the different categories of approaches to manage and deploy cloud services, which can present challenges in how cloud services can be provisioned and managed. In accordance with some implementations of the present disclosure, a modeling and policy framework is provided that can be shared across the different categories of approaches. The modeling and policy framework allows models of cloud services (according to either of the different approaches) to be provided, and to allow policies to be associated with the models so that the policies can guide provisioning of the cloud services and subsequent management of instances of the cloud services—the provisioning of a cloud service instance and a subsequent management of the cloud service instance can be referred to in this disclosure as a fulfillment of the cloud service.

In some implementations of the present disclosure, a service controller that can use components of open-source technologies to generate workflows associated with provisioning and subsequent management of cloud services. The service controller can be a service controller for use in deploying traditional applications in the cloud, and extended to also support cloud native applications. The service controller can thus be used for policy-guided provisioning of cloud services, as well as subsequent policy-guided management of the provisioned instances of the cloud services.

A cloud service includes one or some combination of resources, such as processing resources, storage resources, network resources, and platform and application layers including machine-readable instructions (e.g. applications, protocol stacks, operating systems, a platform. etc.). Provisioning a cloud service can refer to creating the cloud service or otherwise making available the cloud service on demand (at the request of a user). In some examples, the request is a self-service request, where a user can select a design (or purchase/order a design presented as an offering in a catalog and selected (and then managed) via a portal or marketplace.

In other examples, the request can be activated programmatically using an application programming interface (API) that executes the equivalent of the ordering request in the self-service request implementations, to cause provisioning of a cloud service instance or to manage the cloud service instance. As multiple requests are received by the service controller, respective instances of cloud services can be provisioned. The cloud service can be provided by a public cloud, a private cloud, a managed cloud, or a hybrid cloud, or alternatively, can be provided using other infrastructure. In some examples, a cloud service instance can include an “application stack,” which includes an application and a platform on which the application is executed, where the application and platform are provisioned using resources of a cloud (e.g. public cloud, private cloud, managed cloud, or hybrid cloud).

After provisioning of a cloud service instance, lifecycle management of the cloud service instance can be performed. Lifecycle management of a cloud service instance can refer to actions to be performed on or for the provisioned cloud service instance as part of developing the cloud service instance, governing operation of the cloud service instance, monitoring performance and usage of the cloud service, performing maintenance of the cloud service, checking for compliance and security of the cloud service instance, and any other actions that can be performed during the life of the cloud service instance, performing remediation of an issue relating to the cloud service instance, sending a notification of an issue relating to the cloud service instance, and so forth.

In the ensuing discussion, reference is made to using OpenStack components in some implementations of the present disclosure. However, in other examples, other types of components can be employed.

In order to evolve a cloud management tool, such as a service controller, to employ open-source cloud computing components (e.g. OpenStack components, Cloud Foundry components, etc.), such open-source components are evolved to support requirements of the cloud management tools, where the requirements can be expressed in one or multiple policies.

An example of an OpenStack component is an OpenStack service model, which models a cloud service. In some examples, OpenStack service models are described in Murano as provided by OpenStack. Murano introduces an application catalog, which allows application developers and cloud administrators to publish various cloud-ready applications in a catalog. The applications provide models of cloud services, for example. Cloud users can select applications from the Murano catalog to deploy cloud service instances by executing the Murano models (i.e. code that forms the model).

In accordance with some implementations of the present disclosure, policies can be bound to an OpenStack service model, where the binding of such policies guides the provisioning and subsequent management of instances of cloud services. The models have the ability to bind policies, such that the policies can guide the provisioning and then management of cloud service instances.

The policies can be expressed using a policy engine, such as a Congress policy engine provided by OpenStack. Congress provides a mechanism to allow cloud administrators, tenants of clouds, or other users to use a high-level declarative language to express a policy that deployed cloud service instances are to comply with. Examples of policies can be as follows: a particular application is to deployed on a specific machine (or in a zone, or on machine(s) with certain computing capabilities, etc); execution of an application is to be monitored; a first application is allowed to only communicate with a second application; a virtual machine owned by a first tenant should have a public network connection if the first tenant is part of a particular group; a virtual machine of a particular tenant should be deployed in a particular geographic region; and so forth.

OpenStack Congress provides policy as a service. Congress provides an extensible open-source framework for governance and regulatory compliance across cloud services. OpenStack Congress provides a cloud service that is to perform policy enforcement. Plug-ins can be provided to allow an OpenStack service to feed a data model into a policy. The data model refers to the structure and/or schema of data. The data and context are passed through a plug-in to populate against the data model in the policy engine. Policies are written for Congress against the data model. The policies can be evaluated. When a policy is violated, a notification or a remediation script (or more generally, remediation code including machine-readable instructions) can be run. In accordance with some implementations of the present disclosure, a plug-in from Murano can be provided to load into Congress information regarding an environment, information is provided to express Congress policies used to guide the provisioning and management of cloud services, and code (e.g. according to the OpenStack Mistral workflow/orchestration language as discussed further below) can be provided to initiate remediation when policies are found to be violate.

With Openstack, models can be executed as code that can be modified by interacting with policies of Congress. The Congress policies can trigger changes to provisioning of cloud service instances and subsequent management of the cloud service instances. Techniques according to some implementations can be applied in either of the different categories of approaches to manage and deploy cloud services, as discussed above. In addition, self-organizing/managing cloud services can interrogate a policy engine to guide their fulfillment.

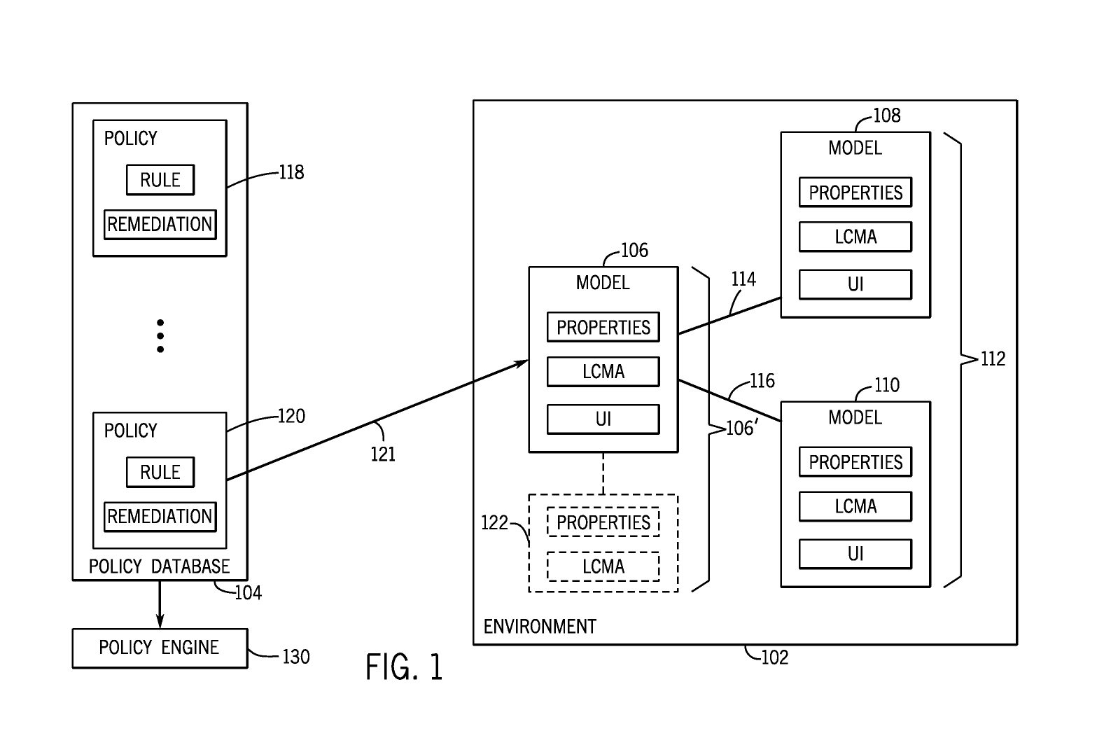

FIG. 1 illustrates an example arrangement that includes an environment 102 of models (e.g. 106, 108, and 110 shown in FIG. 1) arranged in a particular topology 112. Each model 106, 108, or 110 represents a respective cloud service or a component of a cloud service. The topology 112 represents a collection of the models 106, 108, and 110 that are related to one another, based on the interconnecting edges 114 and 116. Although a specific topology 112 of models is shown in FIG. 1, it is noted that in other examples, other topologies of models can be provided. If the models 106, 108, and 110 are according to OpenStack Murano, then the models can be expressed in the Python programming language. The topology can be discovered by walking the model and executing the associated code. In other examples, the models can be expressed using other programming languages or can be declarative.

In examples according to FIG. 1, each model 106, 108, or 110 includes properties (that describe capabilities of a cloud service represented by the model), Lifecycle Management Automation (LCMA) information (information, such as code, relating to conditions and actions for lifecycle management of an instance of the cloud service represented by the model), an User Interface (UI) information (information relating to a UI to be presented for the instance of the cloud service represented by the model).

Note that each model 106, 108, or 110 generally includes code (and other information), where the code is executed to deploy an instance of the respective cloud service, and to perform subsequent lifecycle management of the instance of the cloud service.

The arrangement of FIG. 1 also includes a policy database 104 that includes policies (e.g. 118 and 120 shown in FIG. 1). Each policy 118 or 120 includes a rule (that a cloud service instance is to be validated against). In addition, each policy 118 or 120 can be expanded from solely implementing a rule to also express remediation to be implemented when the rule is violated (i.e. deviates from a target state. Each policy 118 or 120 further includes remediation information that specifies an action to take to address a violation of the rule. Validating a rule of the policy refers to determining whether or not a provisioned cloud service instance is in compliance with the rule of the policy 116. Remediation can be performed in response to a detection of violation of the rule by the provisioned cloud service instance. In some examples, deployment of the instance of the cloud service can be blocked in response to determining that remediation cannot be performed responsive to violation of a rule of a policy. Alternatively, if the instance of the cloud service is already deployed, the instance of the cloud service can be retired (disabled, shut down, deactivated, etc.) in response to determining that remediation cannot be performed responsive to violation of a rule of a policy.

The policies 118 and 120 of the policy database 104 can be according to OpenStack Congress, and the models 106, 108, and 110 of the environment 102 can be according to OpenStack Murano. As noted above, in such examples, plug-ins can be provided to allow an OpenStack service to feed the data associated with the environment and Murano model (e.g. 106, 108, 110, for example) into a policy (e.g. 118 or 120) for evaluation of the policies against the model. The evaluation can be performed by an evaluation system, which can pass a result of the evaluation to the policy engine. In other examples, the policies 118 and 120 and the models 106, 108, and 110 can be of other types. The policies 118 and 120 can be according to the Datalog programming language, or any other language.

The policies 118, 120 and the models 106, 108, 110 can be authored by different entities (e.g. users or code), and/or at different times.

As depicted in FIG. 1, an arrow 121 represents a binding of the policy 120 to the environment 102, and more specifically to the model 106. Binding the policy 120 to the environment 102 allows for fulfillment of a cloud service (or cloud services) of the environment 102, where the fulfillment is guided by the policy 106. Fulfillment of a cloud service can refer to provisioning of an instance of the cloud service, followed by subsequent lifecycle management of the provisioned cloud service instance. The binding represented by 121 is accomplished based on the loading of a data into a policy engine 130 (which can check for violations of policies). In other systems, other mechanism can be used to bind policies to models for evaluating the policies.

In some examples, binding the policy 120 to the model 106 can cause a modification of the model 106, where the modification includes introducing additional code 122 corresponding to the policy 120 into a modified model 106′. The modified model 106′ includes the original information (code, properties, LCMA information, and UI information) of the model 106, as well as the additional code 122 (which can also include properties and LCMA information) of the bound policy 120. The properties of the additional code 122 can describe capabilities associated with the policy 120, and the LCMA information of the additional code 122 relates to lifecycle management conditions and actions relating to the policy 120.

For example, the policy 120 that is to be bound to the environment 102 can specify that monitoring is to be performed during execution of an instance of a cloud service represented by the model 106. The additional code 122 corresponding to the policy 120 that is added to the model 106 to form the modified model 106′ can include code to perform the monitoring of the cloud service instance corresponding to the model 106. The properties of the additional code 122 can specify that the monitoring code is to monitor certain attributes of the cloud service instance, and the LCMA information can relate to lifecycle management actions to take related to the monitoring. The lifecycle management actions can include a remediation action to take if the monitoring indicates that the rule of the policy 120 has been violated.

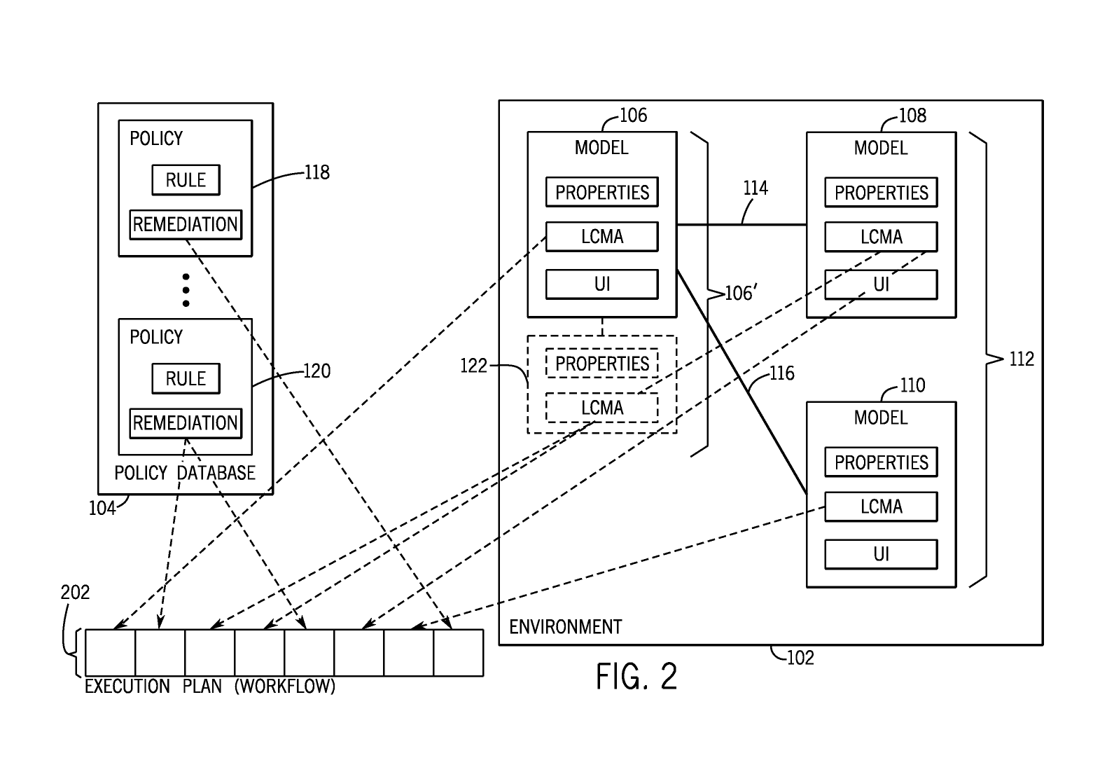

As shown in FIG. 2, after the binding of policies to the environment 102 defined by the models 106, 108, and 110, a workflow 202 (also referred to as an “execution plan”) can be generated. The workflow 202 includes a set of instructions that are executable to fulfill a cloud service (or collection of cloud services as is the case in FIG. 2). As noted above, fulfillment of a cloud service includes provisioning a cloud service instance and subsequently performing lifecycle management of the cloud service instance. The set of instructions can be expressed using at least one of a YAML A'int Markup Language (YAML) or Yet Another Query Language (YAQL). In some examples, code of each model is run, and other code to implement the policies or perform remediation can be inserted.

In FIG. 2, the workflow 202 is represented as a sequence of boxes, where each box includes respective code an original model 106, 108, or 110, the additional code 122 due to the binding of the policy 120 to the model 106, or remediation code from the policy 118 or 120. An arrow pointing to each box indicates the source of the code in the box. In some examples, the remediation code can stop the fulfillment of a cloud service instance if a condition (or conditions) of a policy is (are) not satisfied.

In some example implementations of the present disclosure, the workflow 202 can be a workflow according to Mistral from OpenStack, where Mistral is a workflow service. OpenStack Mistral allows a workflow to be described as a set of tasks and task relations. Providing the workflow 202 provides a fulfillment service (such as an OpenStack fulfillment service) to perform orchestration of provisioning of models (to produce instances of respective cloud services) and then lifecycle management of the instances of cloud services.

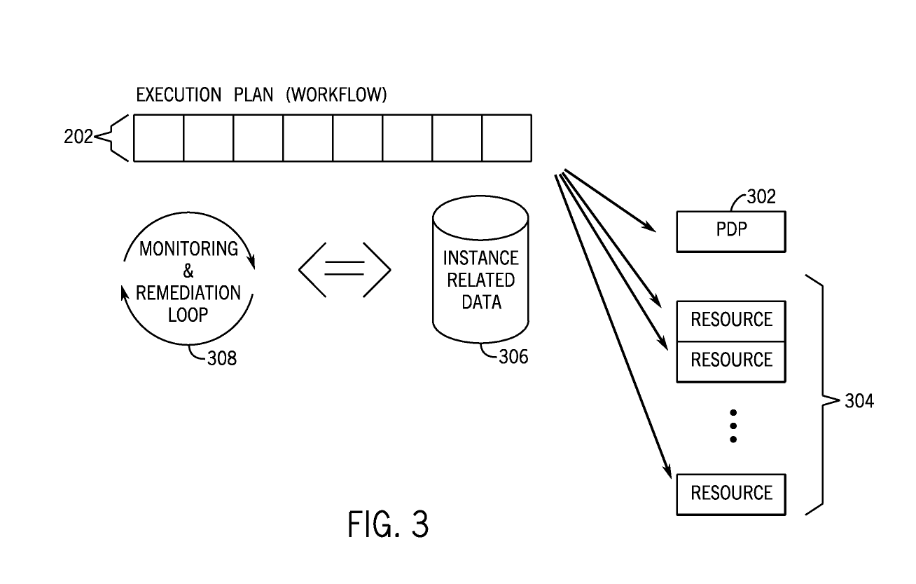

By being able to add remediation code of the policies 118 and 120 to the workflow 202, the policies 118 and 120 can modify the workflow 202. The modified workflow 202 can be used to perform orchestration of the provisioning and subsequent lifecycle management of cloud service instances can be performed using the workflow 202. Orchestration can include calls to different OpenStack services, including Congress, as well as calls to resources, such as resources 304 in FIG. 3 (the calls to the resources 304 are depicted with arrows shown in FIG. 3). The orchestration can be performed using Mistral (Openstack technology) or CloudSlang (an open source flow-based orchestration tool) or any other orchestration technique (such as by using YAML). The resources 304 can include any or some combination of the following, as examples: Heat from OpenStack, where Heat is an orchestration engine to launch multiple composite cloud applications based on templates that can be treated like code; Ansible code, which is a platform to configure and manage computers; Operations Orchestration from Hewlett Packard, which provides Information Technology (IT) process automation; Chef, which automates how an infrastructure is built, deployed, and managed; Puppet, which defines the state of an IT infrastructure, and automatically enforces a target state; Salt, which is an open source configuration management application and remote execution engine; and/or other resources.

In addition, as shown in FIG. 3, the workflow 202 (or any other service or system) can call a policy decision point (PDP) 302 as shown in FIG. 3. The PDP 302 (also referred to as a policy engine) validates rules of policies and potentially implements remediation actions in response to violations of the rules. For example, the PDP 302 can determine whether the execution of lifecycle management of an instance of the cloud service is in compliance or in violation of the rule.

As the workflow 202 executes, the workflow 202 can populate the environment 102 with instance related data, which can be stored in a repository 306. Instance related data can include data output by an executing cloud service instance, data collected during monitoring of the cloud service instance, and so forth.

When cloud service instances are provisioned (or modified) and monitored, remediation can be performed to modify the cloud service instances, or the service controller can also modify the cloud service instances in response to user instructions. In addition, monitoring a cloud service instance (e.g. monitoring performance of an operation of the cloud service instance, monitoring usage of the cloud service instance, monitoring for security of the cloud service instance, monitoring for compliance of the cloud service instance, processing an event of the cloud service instance, and predicting an incident relating to the cloud service instance, etc.) can produce data, events, or metrics that may be loaded (plugged in) into Congress. Alternatively, the data, events, or metrics can be used to make predictions that are loaded into Congress. Note also that processing of events, making predictions of incidents, or making decisions, or performing remediation, can be delegated by the policy engine to other entities (e.g. other services or systems) that process and either update the policy engine data or generate remediation code.

During the execution of the workflow 202, monitoring and remediation can be performed in a monitoring and remediation loop 308. The monitoring can collect monitored data that is added to the repository 306, and the remediation can also produce data indicating remediation actions taken, which can also be added to the repository 306.

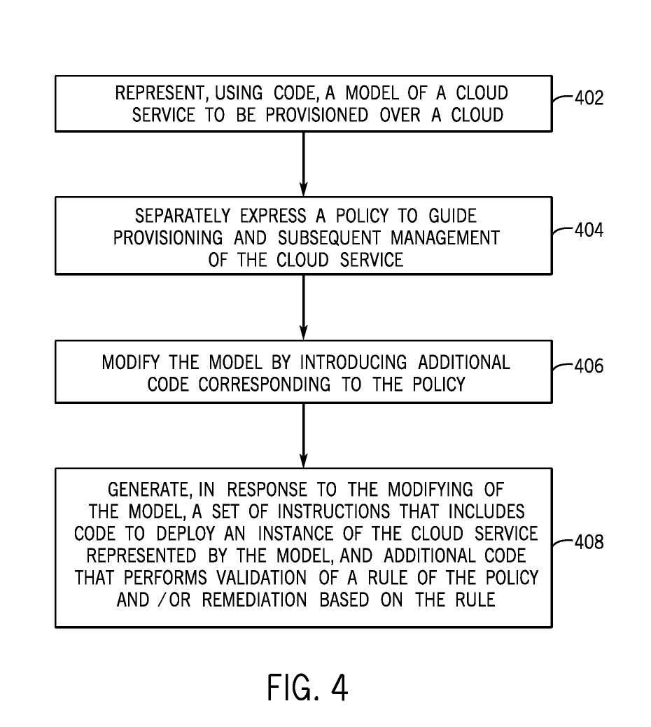

FIG. 4 is a flow diagram of a process according to some implementations. The process includes representing (at 402), using code, a model of a cloud service to be provisioned over a cloud. The process further separately expresses (at 404) a policy to guide provisioning and subsequent management of the cloud service. The expression of the policy can be performed at the same time as or at a different time from the development of the model.

To bind the policy to the model, the model is modified (at 406) by introducing additional code corresponding to the policy into the model, where the introduced code is to validate a rule of the policy and/or to perform remediation based on the rule of the policy. The process generates (at 408), in response to the modifying of the model, a set of instructions (e.g. the workflow 202 shown in FIGS. 2 and 3) that includes (1) code of the model for deploying an instance of the cloud service according to the model, and (2) the additional code that performs validation of the rule of the policy and/or remediation based on the rule of the policy.

In further examples, in addition to the foregoing tasks, the process (and more specifically a policy engine such as PDP 302 in FIG. 3) can evaluate the policy for the model in a context of a deployment in which the instance of the cloud service is to be provided, where the context includes information relating to content, infrastructure, requesters of cloud services, and/or other cloud services. “Content” can include information of a topology of a cloud service, where the topology can characterize capabilities of cloud resources in a cloud, application programming interfaces (APIs), lifecycle management conditions related to lifecycle management actions, and other information. “Infrastructure” can refer to the computing, storage, and/or communication resources useable by a cloud service instance. Requesters of cloud services can refer to tenants of a cloud that can request deployment of a cloud service.

Evaluating the policy allows for a determination of whether a rule has been violated. The evaluation of the policy uses the context, as well as information collected during monitoring, such as for security or compliance purposes. The evaluation of the policy can be based on information collected using a technique selected from among: monitoring data of an instance of the cloud service, monitoring data provided to a policy engine by a plug-in, or receiving an event or incident detected by an event processor (an entity that processes events or incidents) or analytic system (an entity that analyzes events or incidents).

The evaluation of the policy can be triggered by one or any combination of: (1) monitoring of the instance of the cloud service, or (2) an event corresponding to actual occurrence of an incident or a predicted occurrence of the incident.

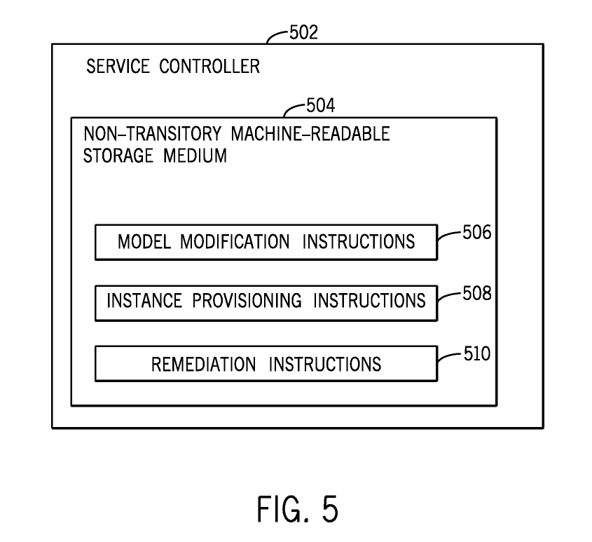

FIG. 5 is a block diagram of a service controller 502 according to some implementations. The service controller 502 can be used to provision an instance of a cloud service, and also to subsequently manage a lifecycle of the cloud service instance. As discussed above, the service controller 502 according to some implementations of the present disclosure can use components of open-source technologies to generate workflows associated with provisioning and subsequent management of cloud services.

The service controller 502 includes a non-transitory machine-readable storage medium (or storage media0 504 that stores machine-readable instructions, including model modification instructions to modify a model in response to binding a policy to the model, instance provisioning instructions 508 to provision an instance of a cloud service, and remediation instructions 510 to perform remediation in response to violation of a rule of the policy.

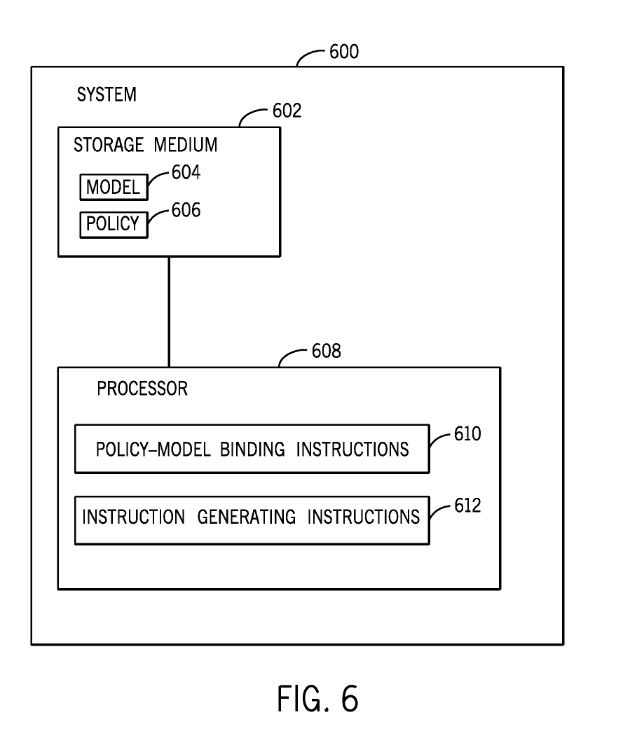

FIG. 6 is a block diagram of a system 600, which can include a storage medium (or storage media) 602 to store a model 604 (e.g. any of models 106, 108, and 110 in FIG. 1) and a policy 606 (e.g. any of policies 118 and 120 in FIG. 1).

The system 600 further includes a processor 608 (or multiple processors) 6o execute machine-readable instructions. A processor can include a microprocessor, a microcontroller, a physical processor module or subsystem, a programmable integrated circuit, a programmable gate array, or another physical control or computing device.

The machine-readable instructions executable by the processor(s) 608 include policy-model binding instructions 610 to bind the policy 606 to the model 604, and instruction generating instructions 612 to generate the set of instructions making up a workflow (e.g. 202 in FIG. 2 or 3). The binding of the policy 606 to the model 604 can include loading a data model into the policy engine (e.g. 130 in FIG. 1) or at least in general making the model available so that the policy can be evaluated. The data model refers to the structure and/or schema of data. The data and context are passed through a plug-in to populate against the data model in the policy engine.

The storage medium (or storage media) 504 or 608 can include one or multiple different forms of memory including semiconductor memory devices such as dynamic or static random access memories (DRAMs or SRAMs), erasable and programmable read-only memories (EPROMs), electrically erasable and programmable read-only memories (EEPROMs) and flash memories; magnetic disks such as fixed, floppy and removable disks; other magnetic media including tape; optical media such as compact disks (CDs) or digital video disks (DVDs); or other types of storage devices. Note that the instructions discussed above can be provided on one computer-readable or machine-readable storage medium, or alternatively, can be provided on multiple computer-readable or machine-readable storage media distributed in a large system having possibly plural nodes. Such computer-readable or machine-readable storage medium or media is (are) considered to be part of an article (or article of manufacture). An article or article of manufacture can refer to any manufactured single component or multiple components. The storage medium or media can be located either in the machine running the machine-readable instructions, or located at a remote site from which machine-readable instructions can be downloaded over a network for execution.

In the foregoing description, numerous details are set forth to provide an understanding of the subject disclosed herein. However, implementations may be practiced without some of these details. Other implementations may include modifications and variations from the details discussed above. It is intended that the appended claims cover such modifications and variations.

What is claimed is:

1. A method of policy-guided fulfillment of a cloud service, comprising:
representing, using code, a model of a cloud service to be provisioned over a cloud;
separately expressing a policy to guide provisioning and subsequent management of the cloud service;
modifying the model by introducing code corresponding to the policy into the model, the introduced code to perform at least one action with respect to a rule of the policy, the at least one action selected from among validating the rule and performing remediation with respect to the rule; and
generating, responsive to the modifying of the model, a set of instructions including code for deploying an instance of the cloud service according to the model, and the introduced code to perform the at least one action with respect to the rule.

2. The method of claim 1, further comprising:
evaluating the policy for the model in a context of a deployment in which the instance of the cloud service is to be provided.

3. The method of claim 2, further comprising:
during execution of the set of instructions, monitoring the instance of the cloud service,
wherein evaluating the policy further uses information collected by the monitoring.

4. The method of claim 3, wherein the information is collected using a technique selected from among: monitoring data of the instance of the cloud service, monitoring data provided to a policy engine by a plug-in, or receiving an event or incident detected by an event processor or analytic system.

5. The method of claim 3, further comprising modifying the instance of the cloud service based on the monitoring.

6. The method of claim 3, wherein the monitoring comprises monitoring for security, monitoring for performance, monitoring for compliance, processing an event, and predicting an incident, and
wherein the information used in performing the evaluating by an evaluation system comprises data, an event, or a predicted incident passed to a policy engine.

7. The method of claim 6, further comprising passing, by the evaluation system, a result of the evaluating to a policy engine.

8. The method of claim 3, further comprising:
during execution of the set of instructions, performing the remediation in response to violation of the rule relating to provisioning of the cloud service or monitoring or management of the instance of the cloud service.

9. The method of claim 2, wherein the evaluating of the policy is triggered by one or any combination of monitoring the instance of the cloud service or an event corresponding to actual occurrence of an incident or a predicted occurrence of the incident.

10. The method of claim 9, further comprising delegating predicting occurrence of an event to another entity.

11. The method of claim 1, wherein the introduced code includes a call to a policy engine to validate the rule, the method further comprising:
determining, by the policy engine, whether the execution of lifecycle management of the instance of the cloud service is in compliance or in violation of the rule.

12. The method of claim 11, wherein the introduced code is to perform remediation responsive to violation of the rule, and wherein the generated set of instructions further comprises a task to perform the remediation responsive to violation of the rule.

13. The method of claim 1, further comprising:
in response to determining that remediation cannot be performed responsive to violation of a rule, performing one of: blocking deployment of the instance of the cloud service, or retiring the instance if already deployed.

14. The method of claim 1, wherein the modifying of the model and the generating of the set of instructions are performed by a service controller that provisions the instance of the cloud service and performs lifecycle management of the provisioned instance of the cloud service.

15. The method of claim 1, wherein the policy-guided fulfillment of the cloud service is for a cloud service provided by a cloud native application.

16. The method of claim 1, wherein the model and the policy are authored by different entities and/or at different times.

17. The method of claim 1, wherein the set of instructions is expressed using at least one of a YAML A'int Markup Language (YAML) or Yet Another Query Language (YAQL).

18. The method of claim 1, wherein the model of the cloud service and policy are provided using OpenStack components.

19. The method of claim 1, further comprising binding the model and the policy by loading the data model into a policy engine.

20. An article comprising at least one non-transitory machine-readable storage medium storing instructions that upon execution cause a service controller to:
modify a model of a cloud service based on a policy including a rule relating to the cloud service, and remediation information relating to a remediation action to be performed in response to violation of the rule;
provision an instance of the cloud service, the provisioning performed responsive to execution of a set of instructions comprising code of the model and a call of a policy engine to validate the rule of the policy; and
performing the remediation action responsive to execution of the set of instructions, the remediation action performed in response to the policy engine detecting violation of the rule.

21. The article of claim 20, wherein the instructions upon execution cause the service controller to:
generate the set of instructions by binding the policy to an environment including the model.

22. The article of claim 20, wherein executing the set of instructions comprises:
monitoring execution of the provisioned instance of the cloud service;
detecting, based on the monitoring, violation of the rule; and
performing the remediation action in response to the detecting of the violation of the rule.

23. A system comprising:
at least one storage medium to store a model of a cloud service to be provisioned over a cloud, and a policy to guide provisioning and subsequent management of the cloud service; and
at least one processor to:
bind the policy to the model by introducing code corresponding to the policy into the model, the introduced code to perform at least one action with respect to a rule of the policy, the at least one action selected from among validating the rule and performing remediation with respect to the rule; and
generate, responsive to the modifying of the model, a set of instructions including code for deploying an instance of the cloud service according to the model, and the introduced code to perform the at least one action with respect to the rule.
